(19) United States
(12) Patent Application Publication
(10) Pub. No.: US 2005/0195132 A1
(43) Pub. Date: Sep. 8, 2005

(54) Plasma display panel and driving method thereof

(76) Inventors: Woo-Joon Chung, Suwon-si (KR); Jin-Sung Kim, Suwon-si (KR); Jin-Ho Yang, Suwon-si (KR); Seung-Hun Chae, Suwon-si (KR); Tae-Seong Kim, Suwon-si (KR)

Correspondence Address: CHRISTIE, PARKER & HALE, LLP, PO BOX 7068, PASADENA, CA, 91109-7068, US

(21) Appl. No.: 11/073,003

(22) Filed: Mar. 4, 2005

(30) Foreign Application Priority Data
Mar. 4, 2004 (KR) 10-2004-0014563

(51) Int. Cl. G09G 3/28

(52) U.S. Cl. 345/60

(57) ABSTRACT

A plasma display panel driving method and apparatus. In a falling period of a reset period, a voltage at a scan electrode is gradually reduced to the voltage Vnf from the voltage Vs while a sustain electrode is maintained at the voltage Va. In an address period, the voltage Va is applied to an address electrode of a discharge cell to be turned on while the sustain electrode is maintained at the voltage Va. Therefore, the number of voltage sources can be reduced by establishing the voltage applied to the sustain electrode to correspond to the voltage Va in the falling period of the reset period and in the address period.

### CROSS REFERENCE TO RELATED APPLICATION

This application claims priority to and the benefit of Korean Patent Application No. 10-2004-0014563, filed on Mar. 4, 2004, the entire content of which is incorporated herein by reference.

### BACKGROUND OF THE INVENTION

1. Field of the Invention

The present invention relates to a plasma display panel (PDP) and a driving method thereof.

2. Discussion of the Related Art

A PDP is a flat display for showing characters or images using plasma generated by gas discharge. PDPs can include pixels numbering more than several millions in a matrix format, in which the number of pixels are determined by the size of the PDP.

Referring to FIG. 1, a conventional PDP structure will now be described. The PDP includes two substrates 1, 6 facing each other with a predetermined gap therebetween. Scan electrodes (Y electrodes) 4 and sustain electrodes (X electrodes) 5 in pairs are formed in parallel on the glass substrate 1. The Y electrodes 4 and the X electrodes 5 are covered with a dielectric layer 2 and a protection film 3. A plurality of address electrodes (A electrodes) 8 are formed on the substrate 6. The address electrodes 8 are covered with an insulator layer 7. Barrier ribs 9 are formed on the insulator layer 7 between the address electrodes 8. Phosphors 10 are formed on the surface of the insulator layer 7 and between the barrier ribs 9. The substrates 1, 6 are provided facing each other with discharge spaces between the substrates 1, 6 so that the Y electrodes 4 and the X electrodes 5 can cross the A electrodes 8. A discharge space 11 between an X electrode 8 and a crossing part of a pair of a Y electrode 4 and an X electrode 5 forms a discharge cell 12, which is schematically indicated.

FIG. 2 shows a conventional plasma display panel driving waveform diagram. Each subfield has a reset period, an address period, and a sustain period. The reset period includes an erase period, a rising period, and a falling period, in which wall charge states of a previous sustain are erased, and wall charges are set up in order to stably perform a next address. In the address period, the cells that are turned on and the cells that are not turned on in a panel are selected, and wall charges are accumulated to the cells that are turned on (i.e., the addressed cells). In the sustain period, discharge for actually displaying pictures on the addressed cells is performed.

Recently, in order to reduce the total voltage levels other than those of the sustain period, the voltage at the Y electrode is reduced to a negative voltage Vnf in the falling period of the reset period, and the voltage applied to the Y electrode of the discharge cell to be turned on in the address period is reduced to a negative voltage VscL. In order to prevent the discharge cell which is not addressed from being misfired in the sustain period, the voltage Ve is established so that the difference between the voltage Ve applied to the X electrode and the negative voltage Vnf applied to the Y electrode in the falling period of the reset period may be higher than the voltage Vs applied to the X electrode. The voltage Ve is established to be lower than the voltage Vs since the voltage Vnf is a negative voltage. Accordingly, the driving waveform shown in FIG. 2 requires a plurality of voltages Ve, Vnf, Vs, Vset, Va, VscH, and VscL, which increase production cost and, in turn, drives up overall system cost, because of the increased number of voltage sources needed.

### SUMMARY OF THE INVENTION

In accordance with the present invention a driving method for driving a plasma display panel and for reducing the number of voltage sources, is provided. The method discloses driving a plasma display panel having a plurality of first electrodes and second electrodes formed in parallel on a first substrate, and a plurality of third electrodes formed on a second substrate wherein a discharge cell is formed by first, second, and third electrodes. A voltage at the second electrode is gradually reduced from a second voltage to a third voltage while the first electrode is maintained at a first voltage in a reset period, and a fourth voltage is applied to the second electrode and the first voltage is applied to the third electrode in order to select a discharge cell to be turned on in an address period.

Further, the present invention discloses a plasma display panel having a panel, a voltage source, and a driver. The panel includes a plurality of sustain electrodes, a plurality of scan electrodes, and a plurality of address electrodes. The driver respectively applies a first voltage and a second voltage to the scan electrode and the address electrode of a discharge cell to be turned on while applying a third voltage to the sustain electrode in an address period. The voltage source supplies the first voltage, the second voltage and the third voltage to the driver, and uses the second voltage to supply the third voltage to the driver.

The present invention still further discloses a method for dividing a plasma display panel in which a frame has a plurality of subfields, and discharge cells are formed by a plurality of first electrodes and second electrodes. In a reset period, a voltage at the second electrode is gradually reduced while the first voltage is maintained at a first voltage. In an address period, a discharge cell to be turned on is selected while the first electrode is maintained at a second voltage. In a sustain period, a sustain discharge pulse which alternately has a third voltage and a fourth voltage lower than the third voltage is applied to the first electrode and the second electrode. At least one of the first voltage and the second voltage corresponds to a middle voltage between the third voltage and the fourth voltage.

### BRIEF DESCRIPTION OF THE DRAWINGS

FIG. 1 shows a partial perspective view of a conventional PDP.

FIG. 2 shows a conventional plasma display panel driving waveform diagram.

FIG. 3 shows an exploded perspective view of a PDP according to an exemplary embodiment of the present invention.

FIG. 4 shows a schematic plan view of a PDP according to an exemplary embodiment of the present invention.

FIG. 5 shows a block diagram layout of a chassis base according to an exemplary embodiment of the present invention.

FIG. 6 shows a driving waveform diagram of a plasma display panel according to a first exemplary embodiment of the present invention.

FIG. 7 shows a driving waveform diagram of a plasma display panel according to a second exemplary embodiment of the present invention.

### DETAILED DESCRIPTION

As described herein, the wall charges represent the charges that are formed near each electrode on the wall (e.g., a dielectric layer) of the discharge cell. The wall charges are not actually contacted with the electrode, but they are depicted to be “formed,” “accumulated,” and “piled” on the electrode. Also, the wall voltage represents a potential difference formed on the wall of the discharge cell by the wall charges.

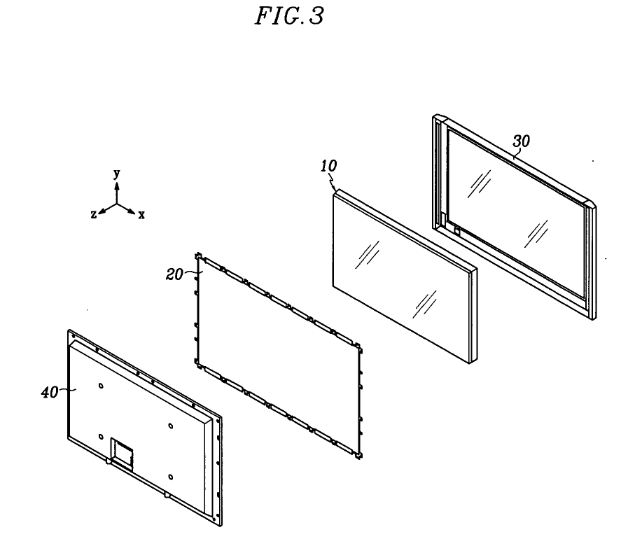

Referring now to FIG. 3, the plasma display includes a PDP 10, a chassis base 20, a front case 30, and a rear case 40. The chassis base 20 is provided on the opposite side of a surface of the PDP 10 for displaying images, and is combined with the PDP 10. The front and rear cases 30, 40 are respectively arranged on the front side of the PDP 10 and the rear side of the chassis base 20, and are combined with the PDP 10 and the chassis base 20 to thus configure a plasma display.

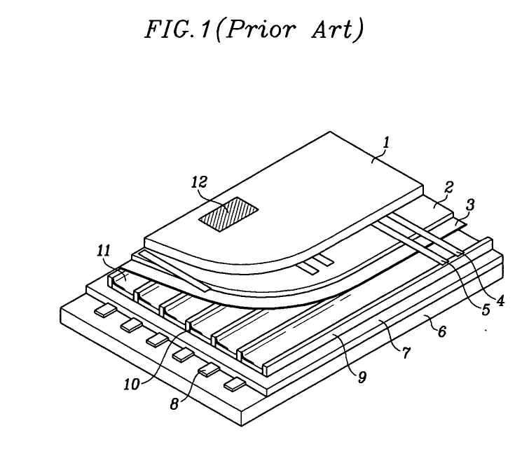

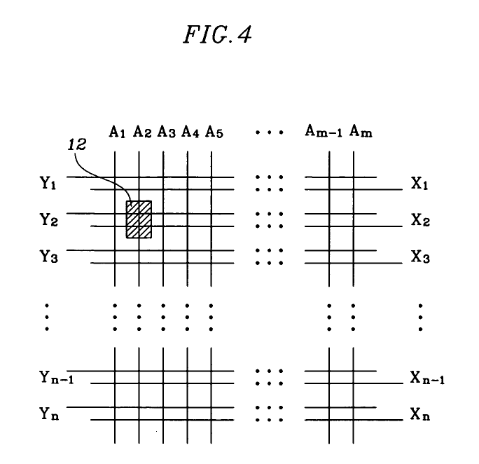

As shown in FIG. 4, the PDP 10 of both FIG. 1 and FIG. 3 which is used in accordance with the exemplary embodiments of the present invention, includes a plurality of A electrodes A1 to Am arranged in a column direction, and a plurality of Y electrodes Y1 to Yn and X electrodes X1 to Xn arranged in a row direction. The X electrodes X1 to Xn are formed to correspond to the respective Y electrodes Y1 to Yn, and terminals thereof are coupled in common. The PDP 10 includes a substrate on which the X electrodes X1 to Xn and the Y electrodes Y1 to Yn are arranged, and a substrate on which the A electrodes A1 to Am are arranged. The two substrates are arranged to face each other with discharge spaces therebetween so that the Y electrodes Y1 to Yn cross the A electrodes A1 to Am, and the X electrodes X1 to Xn cross the A electrodes A1 to Am. In this instance, the discharge spaces formed at the crossing points of the A electrodes A1 to Am and the X and Y electrodes X1 to Xn and Y1 to Yn form discharge cells 11.

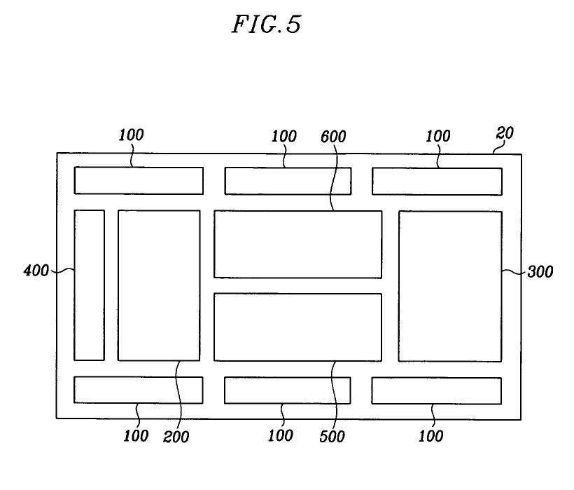

As shown in FIG. 5, boards 100, 200, 300, 400, 500, 600 for driving the PDP 10 are formed on the chassis base 20. The address buffer boards 100 may be respectively formed on the tops and bottoms of the chassis base 20, and the address buffer boards 100 can be combined into a single board. FIG. 5 exemplifies a dual driving plasma display device. However, the address buffer boards 100 may be arranged on the top or bottom of the chassis base 20 in the case of single driving. The address buffer boards 100 receive address driving control signals from the image processing and logic board 500, and apply voltages for selecting discharge cells to be displayed to the respective A electrodes A1 to Am.

The scan driving board 200 and the sustain driving board 300 may be provided on the left and right sides of the chassis base 20, and the scan driving board 200 is coupled to the Y electrodes Y1 to Yn through the scan buffer board 400. The scan buffer board 400 applies the voltage for sequentially selecting the Y electrodes Y1 to Yn during the address period to the Y electrodes Y1 to Yn. The scan driving board 200 and the sustain driving board 300 receive driving signals from the image processing and logic board 500, and apply driving voltages to the Y electrodes Y1 to Yn and the X electrodes X1 to Xn. The scan driving board 200 and the sustain driving board 300 are separately provided as shown in FIG. 5, and they can also be combined into a single board, and the scan buffer board 400 and the scan driving board 200 can also be formed into a single body.

The image processing and logic board 500 externally receives image signals, generates control signals for driving the A electrodes A1 to Am and control signals for driving the Y and X electrodes Y1 to Yn and X1 to Xn, and respectively applies the same to the address buffer boards 100, the scan driving board 200, and the sustain driving board 300. The power board 600 provides voltage sources for driving the plasma display. The image processing and logic board 500 and the power board 600 may be provided at the center of the chassis base 20.

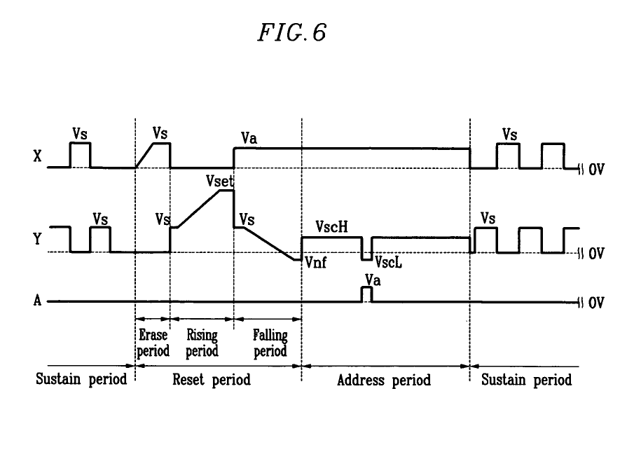

Referring now to FIG. 6, a PDP driving waveform according to an exemplary embodiment of the present invention will be described. For ease of description, the driving waveform applied to the Y, X, and A electrodes forming an individual cell will be described. As shown, each subfield has a reset period, an address period, and a sustain period.

The reset period includes an erase period, a rising period, and a falling period. In the erase period the charges formed by a sustain discharge in the sustain period of a previous subfield are erased. In the rising period the wall charges are formed on the Y, X, and A electrodes. In the falling period part of wall charges formed in the rising period are erased and thereby the address discharge is activated.

In the address period discharge cells are selected for generating a sustain discharge in the sustain period from among a plurality of discharge cells. In the sustain period sustain discharge pulses are alternately applied to the Y electrode and the X electrode and sustain-discharge the discharge cells selected in the address period.

In the sustain period of the previous subfield, negative wall charges are accumulated on the Y electrode and positive wall charges are accumulated on the X electrode by the sustain discharge between the Y and X electrodes.

In the erase period, the voltage at the X electrode is gradually increased to the voltage Vs from a reference voltage (0V in FIG. 6) while the voltage at the Y electrode is maintained at the reference voltage. The wall charges formed on the X and Y electrodes are then erased. Alternatively, the erase period for erasing the wall charges formed in the sustain period of the previous subfield may be eliminated.

In the rising period, the voltage at the Y electrode is gradually increased in a ramp to the voltage Vset from the voltage Vs while the voltage at the X electrode is maintained at the 0V reference voltage. When a weak discharge is generated between the Y and X electrodes and between the Y and X electrodes while the voltage at the Y electrode is increased, negative wall charges are formed on the Y electrode and positive wall charges are formed on the X and A electrodes. When the voltage at the electrode is gradually varied as shown in FIG. 6, a weak discharge is generated in a cell and wall charges are formed so that the summation of the externally applied voltage and the wall voltage of the cell may maintain a firing voltage, which is disclosed in U.S. Pat. No. 5,745,086 by Weber. The voltage Vset is defined to be a voltage which is high enough to generate discharges in the cells since the cells are to be reset in the reset period. Also, the voltage Vs is the highest one from among the voltages applied to the Y electrode in the sustain period, and is lower than the firing voltage between the Y and X electrodes.

In the falling period, the voltage at the Y electrode is gradually reduced to the voltage Vnf from the voltage Vs while the voltage at the X electrode is maintained at the voltage Va. A weak discharge is generated between the Y and X electrodes and between the Y and A electrodes, and the negative wall charges formed on the Y electrode and the positive wall charges formed on the X and A electrodes are erased while the voltage at the Y electrode is reduced.

In the address period, in order to select the discharge cell, a scan pulse with the voltage VscL and an address pulse with the voltage Va are sequentially applied to the Y electrode and the A electrode while the voltage at the X electrode is maintained at the voltage Va. The Y electrode which is not selected is biased with the voltage VscH which is higher than the voltage VscL, and the 0V reference voltage is applied to the A electrode of the cell which is not to be turned on. An address discharge is generated in the discharge cell formed by the A electrode to which the voltage Va is applied and the Y electrode to which the voltage VscL is applied. The positive wall charges are formed on the Y electrode. The negative wall charges are formed on the X electrode and also on the A electrode.

In the sustain period, a sustain discharge pulse of the voltage Vs is sequentially applied to the Y electrode and the X electrode. In this instance, the sustain discharge pulse controls the voltage difference between the Y and X electrode to alternately be the voltage Vs and the 0V reference voltage. A discharge is generated at the Y electrode and the X electrode by the wall voltage formed between the Y and X electrodes by the address discharge in the address period, and the voltage Vs. The process of applying the sustain discharge pulse with the voltage Vs to the Y electrode and the process of applying the sustain discharge pulse with the voltage Vs to the X electrode are repeated by as many as the number of weights represented by the corresponding subfield.

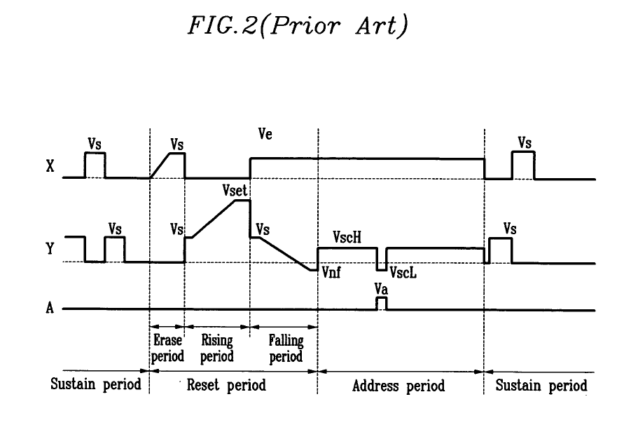

Therefore, when the voltage applied to the X electrode in the falling period of the reset period and the address period is established to be the voltage Va, a voltage source for supplying the voltage Ve is not needed as compared to the driving waveform of FIG. 2, and the number of voltage sources can thereby be reduced.

When the voltage Va is very low, the difference between the voltage Va and the voltage VscL may be equal to or lower than the voltage Vs, the wall charges are insufficiently erased between the X and Y electrodes in the falling period, and the discharge cell in which no address discharge is generated in the address period may be discharged by the voltage Vs applied to the X electrode in the sustain period. Hence, the difference between the voltage Va and the voltage VscL is established to be greater than the voltage Vs. That is, the difference between the voltage Va and the voltage VscL can be controlled to be greater than the voltage Vs by controlling the voltage Va to be higher than the voltage Va in the waveform of FIG. 2 or controlling the voltage VscL to be lower than the voltage VscL in the waveform of FIG. 2.

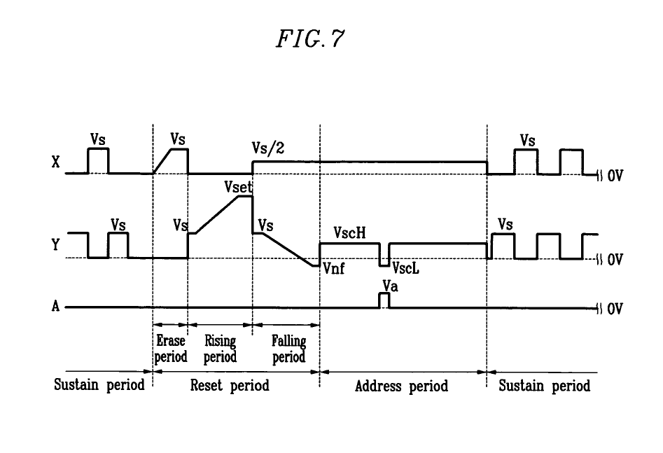

The voltage Va is applied to the X electrode in the falling period of the reset period and the address period, and in addition to this, as shown in FIG. 7, the voltage Vs/2 is applicable to the X electrode in the falling period of the reset period and the address period. In this instance, the voltage Vs/2 is charged in a capacitor when the sustain discharge pulse is applied by using a power recovery circuit in the sustain period. The voltage Vs/2 is used as a voltage when the voltage Vs is applied to one of the Y and X electrodes because of resonance by a panel capacitor and an inductor. Accordingly, no additional voltage source for supplying the voltage Vs/2 to the X electrode is needed when applying the voltage Vs/2 thereto in the falling period of the reset period and the address period, and the number of voltage sources is reduced as compared to that needed for the prior art driving waveform of FIG. 2.

In essence, by establishing the bias voltage at the sustain electrode to be the voltage Va or Vs/2 in the falling period of the reset period and the address period, the number of voltage sources may be reduced, saving production costs.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for driving a plasma display panel having a plurality of first electrodes and second electrodes formed in parallel on a first substrate, and a plurality of third electrodes formed on a second substrate, wherein a discharge cell is formed by a respective first electrode, second electrode, and third electrode, the method comprising:
gradually reducing a voltage at the second electrode from a second voltage to a third voltage while the first electrode is maintained at a first voltage in a reset period; and
applying a fourth voltage to the second electrode and applying the first voltage to the third electrode in order to select a discharge cell to be turned on in an address period.

2. The method of claim 1, wherein the first electrode is maintained at the first voltage in the address period.

3. The method of claim 1, wherein the third voltage is a negative voltage.

4. The method of claim 1, wherein a difference between the first voltage and the third voltage is greater than a difference between voltages applied to the first electrode and the second electrode in a sustain period for sustain discharge.

5. The method of claim 2, wherein a difference between the first voltage and the third voltage is greater than a difference between voltages applied to the first and second electrodes in a sustain period for sustain discharge.

6. The method of claim 3, wherein a difference between the first voltage and the third voltage is greater than a difference between voltages applied to the first and second electrodes in a sustain period for sustain discharge.

7. A plasma display panel comprising:
a panel including a plurality of sustain electrodes, a plurality of scan electrodes, and a plurality of address electrodes;
a driver for respectively applying a first voltage and a second voltage to the scan electrode and the address electrode of a discharge cell to be turned on while applying a third voltage to the sustain electrode in an address period; and
a voltage source for supplying the first voltage, the second voltage and the third voltage to the driver and for using the second voltage to supply the third voltage to the driver.

8. The plasma display panel of claim 7, wherein the driver applies the second voltage to the sustain electrode when a voltage at the scan electrode gradually falls in a reset period.

9. A method for driving a plasma display panel in which a frame has a plurality of subfields, and discharge cells are formed by a plurality of first electrodes and second electrodes, the method comprising:
in a reset period, gradually reducing a voltage at the second electrode while the first voltage is maintained at a first voltage;
in an address period, selecting a discharge cell to be turned on while the first electrode is maintained at a second voltage; and
in a sustain period, applying a sustain discharge pulse which alternately has a third voltage and a fourth voltage lower than the third voltage to the first electrode and the second electrode,
wherein at least one of the first voltage and the second voltage corresponds to a middle voltage between the third voltage and the fourth voltage.
